(19) United States
(12) Patent Application Publication
(10) Pub. No.: US 2015/0304709 A1
(43) Pub. Date: Oct. 22, 2015

(54) METHOD AND APPARATUS FOR ESTIMATING VIDEO QUALITY

(71) Applicants: Qian ZHANG, (US); Ning LIAO, (US); Fan ZHANG, (US); Zhibo CHEN, (US)

(72) Inventors: Qian Zhang, Beijing (CN); Ning Liao, Beijing (CN); Fan Zhang, Wuhan (CN); Zhibo Chen, Beijing (CN)

(21) Appl. No.: 14/443,841

(22) PCT Filed: Nov. 30, 2012
(86) PCT No.: PCT/CN2012/085618

§ 371 Date: May 19, 2015

(51) Int. Cl. H04N 21/44; H04N 21/61; H04N 21/647; H04N 21/643; H04N 21/442; H04N 21/234

(52) U.S. Cl. CPC H04N 21/44008; H04N 21/44209; H04N 21/23418; H04N 21/64738; H04N 21/6473; H04N 21/64769; H04N 21/64322; H04N 21/6125

(57) ABSTRACT

A method and apparatus are disclosed for predicting subjective quality of a video contained in a bit stream on a packet layer. Header information of the bit-stream is parsed and frame layer information, such as frame type, is estimated. Visible artifact levels are then estimated based on frame layer information. An overall artifact level and quality metric are estimated based on artifact levels for individual frames with other parameters. Specifically, different weighting factors are used for different frame types when estimating the levels of initial visible artifacts and propagated visible artifacts. The number of slices per frame is used as a parameter when estimating the overall artifact level for the video. Moreover, the quality assessment model considers quality loss caused by both coding and channel artifacts.

### TECHNICAL FIELD

This invention relates to video quality measurement, and more particularly, to a method and apparatus for estimating video quality for an encoded video.

### BACKGROUND

With the development of IP networks, video communication over wired and wireless IP networks (for example, IPTV service) has become popular. Unlike traditional video transmission over cable networks, video delivery over IP networks is less reliable. Consequently, in addition to the quality loss from video compression, the video quality is further degraded when a video is transmitted through IP networks. A successful video quality modeling tool needs to rate the quality degradation caused by network transmission impairment (for example, packet losses, transmission delays, and transmission jitters), in addition to quality degradation caused by video compression.

### SUMMARY

The present principles provide a method for estimating video quality of a video, comprising the steps of: accessing a bit stream including the video; determining a picture type of a picture in the video as one of a scene-cut frame, non scene-cut I frame, P frame, and B frame; and estimating the video quality for the video in response to the determined picture type as described below. The present principles also provide an apparatus for performing these steps.

The present principles also provide a method for estimating video quality of a video, comprising the steps of: accessing a bit stream including the video; determining a picture type of a picture in the video as one of a scene-cut frame, non scene-cut I frame, P frame, and B frame, wherein the picture type of the picture is determined in response to at least one of a size of the picture and a corresponding GOP length; determining an initial artifact level and a propagated artifact level in response to the picture type; determining an overall artifact level for the picture in response to the initial artifact level and the propagated artifact level; and estimating the video quality for the video in response to the determined overall artifact level as described below. The present principles also provide an apparatus for performing these steps.

The present principles also provide a computer readable storage medium having stored thereon instructions for estimating video quality of a video according to the methods described above.

### BRIEF DESCRIPTION OF THE DRAWINGS

FIG. 1 is a block diagram depicting an example of a video quality monitor, in accordance with an embodiment of the present principles.

FIG. 2 is a flow diagram depicting an example of estimating video quality, in accordance with an embodiment of the present principles.

FIG. 3 is a flow diagram depicting an example of estimating picture type, in accordance with an embodiment of the present principles.

FIG. 4 is a pictorial example depicting the number of bytes and the picture type for each picture in a video sequence.

FIG. 5 is a pictorial example depicting video quality estimation results.

FIG. 6 is a block diagram depicting an example of a video processing system that may be used with one or more implementations.

### DETAILED DESCRIPTION

In recent years, IPTV (Internet Protocol television) service has become one of the most promising applications over the next generation network. For IPTV service to meet expectation of end users, predicting and monitoring quality of service (QoS) and quality of experience (QoE) are in great need.

Some QoE assessment methods have been developed for the purpose of network quality planning and in-service quality monitoring. ITU-T (International Telecommunication Union, Telecommunication Standardization Sector) has led study works and standardized recommendations on these applications. ITU-T Recommendation G.107 (“The E-model, a computational model for use in transmission planning,” March, 2005) and G.1070 (“Opinion model for video-telephony applications,” April, 2007) provide quality planning models, while ITU-T P.NAMS (non-intrusive parametric model for assessment of performance of multimedia streaming) and P.NBAMS (non-intrusive bit stream model for assessment of performance of multimedia streaming) are proposed for quality monitoring.

As payload information is usually encrypted in IPTV, a bit stream level quality model (for example, P.NBAMS) cannot be applied at a device where an encrypted bit stream cannot be decrypted. A packet layer quality model (for example, P.NAMS) can be applied to estimate perceived video quality by using only packet header information. For instance, frame boundaries may be detected by using RTP (Real-time Transport Protocol) timestamps, the number of lost packets may be counted by using RTP sequence numbers, and the number of bytes in a frame may be estimated by the number of TS (Transport Stream) packets in the TS header.

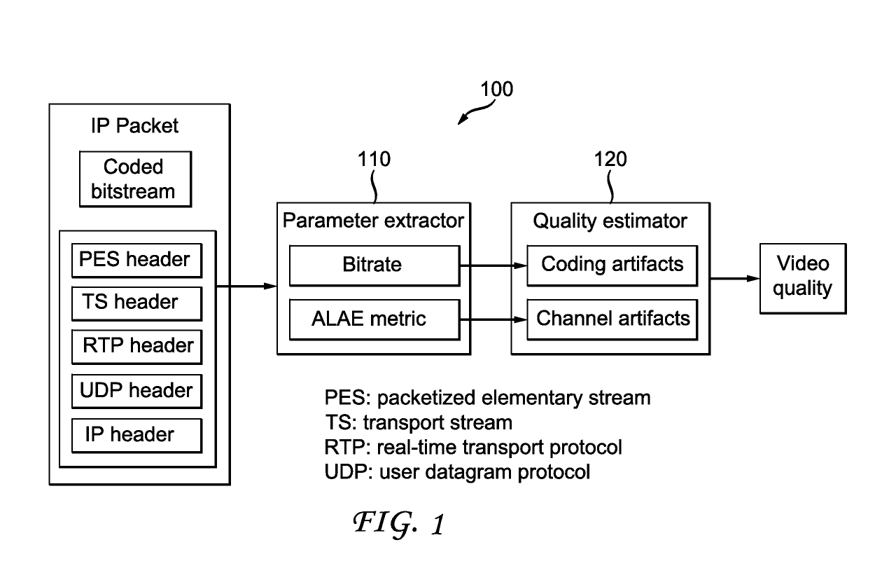

An exemplary packet layer quality monitor is shown in FIG. 1, where the model input is packet header information and the output is estimated quality. The packet header can be, for example, but not limited to, PES (Packetized Elementary Stream) header, TS header, RTP header, UDP (User Datagram Protocol) header, and IP header. Since the packet layer model only uses packet header information to predict quality, the computation is light. Thus, a packet layer quality monitor is useful when the processing capacity is limited, for example, when monitoring QoE in a set-top box (STB).

In a packet layer quality monitoring framework as shown in FIG. 1, there are two key components: parameter extractor (110) and quality estimator (120). The parameter extractor extracts model input parameters by analyzing packet header. In one embodiment, the parameter extractor may parse the header and derive the frame rate, the bitrate, the number of bits or bytes for a frame, the number of lost packets for a frame, and the total number of packets for a frame. Based on these parameters, the parameter extractor may estimate frame layer information (e.g., frame type) and further derive artifact level. Given the output of the parameter extractor, the quality estimator may estimate coding artifacts, channel artifacts, and the video quality using the extracted parameters.

The present principles relate to a no-reference, packet based video quality measurement tool. The quality prediction method is of no-reference or non-intrusive type, and is based on header information, for example, header of MPEG-2 transport stream over RTP. That is, it does not need access to the decoded video. The tool can be operated in user terminals, set-up boxes, home gateways, routers, or video streaming servers.

In the present application, the term “frame” is used interchangeably with “picture.”

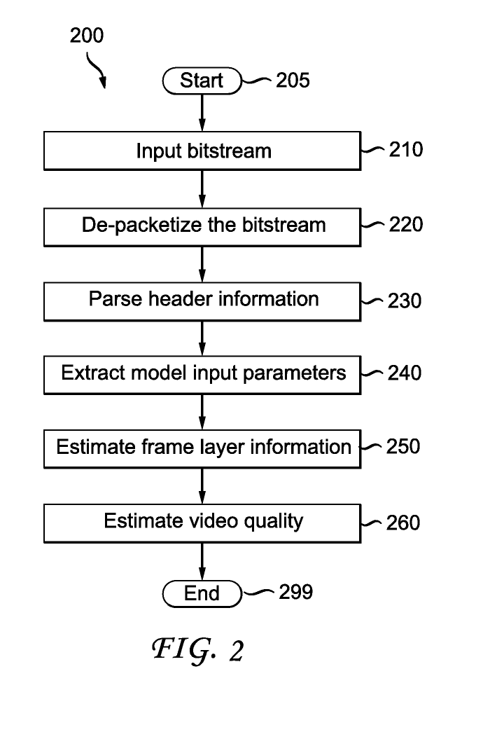

An exemplary method 200 for assessing video quality according to the present principles is shown in FIG. 2. Method 200 starts at step 205. The bit stream, for example, an encoded transport stream with RTP packet header, is input at step 210. The bit stream is de-packetized at step 220 and the header information is parsed at step 230. Subsequently, the model input parameters are extracted at step 240. Frame layer information, for example, frame type, is estimated at step 250. Based on extracted parameters and estimated frame layer information, artifact levels and video quality are estimated at step 260. Method 200 ends at step 299.

It should be noticed that the assessment method can also be used with transport protocols other than RTP, for example, transport stream over TS. The frame boundaries may be detected by timestamps in TS header, and the transmit order and occurred loss may be computed by a continuity counter in TS header.

In the following, the steps of frame type estimation, artifact level estimation, and quality prediction are described in further detail.

### Frame Type Estimation

Losses happening in different types of frames may result in different levels of visible artifacts, which lead to different perceived quality levels to viewers. For example, the effect of a loss occurring in a reference I or P frame is more severe than that in a non-reference B frame. In the present embodiments, the frame type is estimated based on an estimated GOP structure and the number of bytes in a frame.

We define four frame types (ftype): {ftype=4 (scene-cut frame), ftype=3 (non scene-cut I frame), ftype=2 (P frame), ftype=1 (B frame)}.

Whether a frame is an Intra frame can be determined from a syntax element, for example, “random_access_indicator” in the adaptation field of transport stream (TS) packet.

A scene-cut frame is estimated as a frame that scene cut may happen and thus usually has a high encoding bitrate. A scene-cut frame may occur at an Intra frame or a non-Intra frame. For a bit stream with an adaptive GOP structure, scene-cut frames mainly correspond to I frames with quite short GOP length. For a bit stream with a fixed GOP length, scene-cut frames may be non-Intra frames with quite large numbers of bytes.

Considering different implementations of an encoder with different GOP structures, we estimate frame i (i E GOP) as a scene-cut frame using the following equation:

$${ftype}_{i} = 4 if \{ \begin{matrix}{bytes}_{i} > {PRE}_{IBytes} \& & i ∈ non \text{-} intra frame \\ {glen}_{j} < 0.5 ⋆ {AVE}_{GOPLength} \& & i ∈ intra frame\end{matrix} \qquad \begin{matrix}( 1.1 ) \\ ( 1.2 )\end{matrix}$$

where bytesᵢ is the number of bytes in frame i, PRE_{IBytes} is the number of bytes in a previous I frame, glenⱼ is the GOP length of GOP j containing frame i, and AVE_{GOPLength} is the average GOP length. A GOP starts from a scene-cut frame or I frame till the next scene-cut frame or I frame.

To decide whether frame i (i E GOPⱼ & i ε non-intra frame) is a P or B frame, AVE_bytesⱼ is calculated as the average number of bytes of GOP j by excluding the scene-cut frame or I frame in the GOP. If bytes, is larger than AVE_bytesⱼ, frame i is determined to be a P frame, and is determined to be a B frame otherwise. That is,

ftypeᵢ=2 if bytesᵢ>AVE_bytesⱼ (2.1)

ftypeᵢ=3 if bytes,AVE_bytesⱼ (2.2)

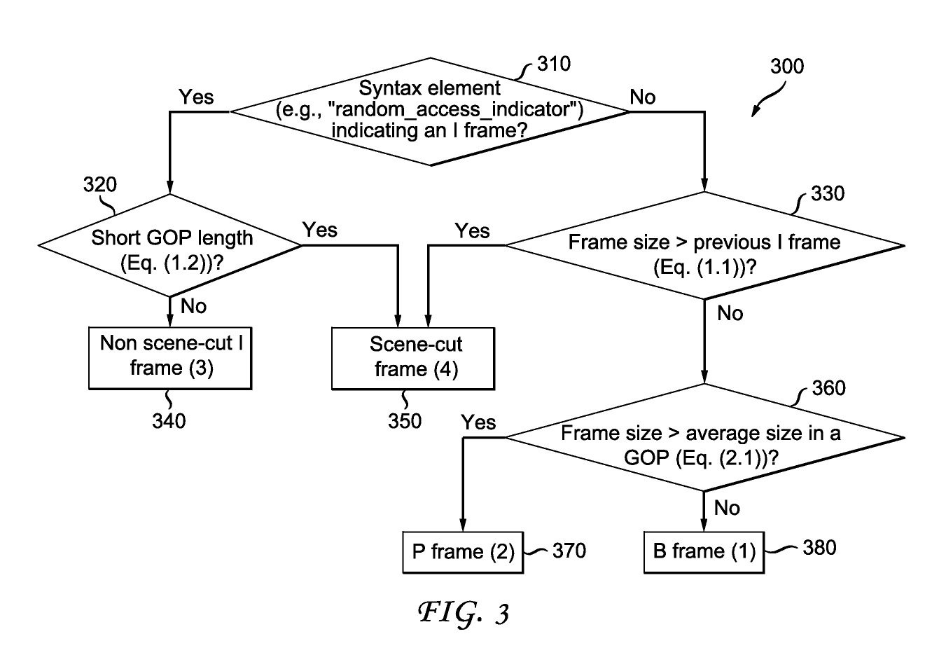

An exemplary method 300 for determining frame type for a frame according to the present principles is shown in FIG. 3. At step 310, it checks a syntax element indicating an Intra frame, for example, it checks whether syntax element “random_access_indicator” equals 1. If the frame is an Intra frame, it checks whether it corresponds to a short GOP, for example, it checks whether the condition specified in Eq. (1.2) is satisfied. If an Intra frame corresponds to a short GOP, the Intra frame is estimated to be a scene-cut frame (350), and otherwise is estimated to a non scene-cut I frame (340).

For a non-Intra frame, it checks whether the frame size is very large, for example, it checks whether the frame size is greater than the frame size of a previous I frame as specified in Eq. (1.1). If the frame size is very large, the non-Intra frame is estimated to be a scene-cut frame (350). Otherwise, if the frame size is not very large, it checks whether the frame size is large, for example, it checks whether the frame size is greater than the average frame size of the GOP as specified in Eq. (2.1). If the frame size is large, the non-Intra frame is estimated to be a P frame (370), and otherwise a B frame (380).

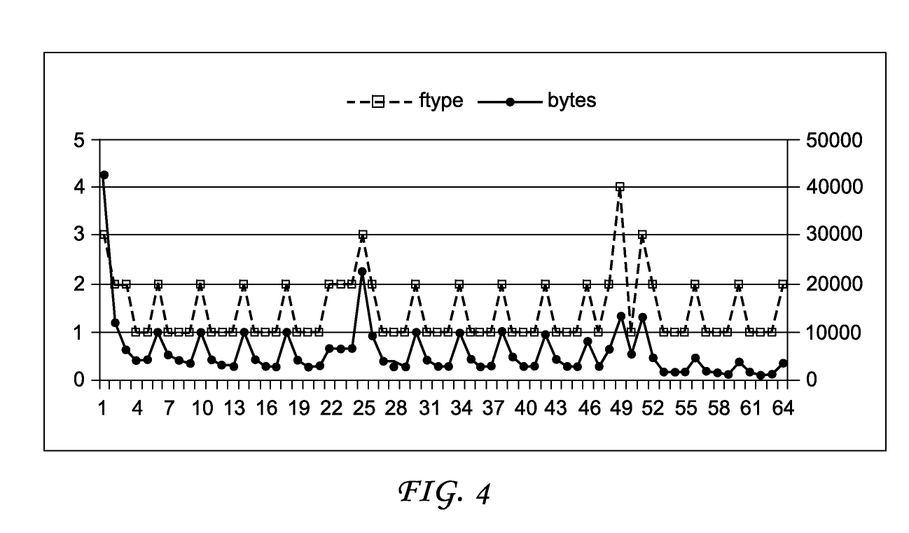

For an exemplary video sequence, FIG. 4 shows the number of bytes for each frame in the video sequence and the estimated frame type for each frame, wherein the x-axis indicates the frame index, the left y-axis indicates the frame type, and the right y-axis indicates the number of bytes.

### Artifact Level Estimation

An Averaged Loss Artifact Extension (ALAE) metric is estimated based on estimated frame types and other parameters. The ALAE metric is estimated to measure visible degradation caused by video transmission loss. For each frame i, a Loss Artifact Extension (LAE) can be calculated as the sum of Initial Artifact (IA) caused by the loss in the current frame and Propagated Artifact (PA) caused by the loss in reference frames:

LAEᵢ=IAᵢ+PAᵢ. (3)

The initial artifact level may be calculated as:

$${IA}_{i} = {w}_{i}^{IA} \times \frac{{lp}_{i}}{{tp}_{i}} , \qquad ( 4 )$$

where lpᵢ is the number of lost packets (including packets lost due to unreliable transmission and packets ensuing the lost packets in the current frame), tpᵢ is the number of total packets (including the estimated number of lost packets), and wᵢ^{IA} is a weighting factor, which depends on the frame type because losses occurred in different types of frame cause different levels of visible artifacts. In one exemplary embodiment, the frame type and the corresponding weighing factor is set as shown in TABLE 1. Because a loss occurred in a scene-cut frame often causes most serious visible artifacts for viewers, its weighting factor is set to be the largest. A non scene-cut I frame and P frame usually cause similar levels of visible artifacts since they are both used as reference frames, so their weighting factors are set to be the same.

TABLE 1

| | scene-cut | non scene-cut | | |
|---|---|---|---|---|
| Frame type | frame | I frame | P frame | B frame |
| wᵢ^{IA} | 1.0 | 0.3 | 0.3 | 0.01 |

The propagated artifact may be calculated as:

PAᵢ=wᵢ^{PA}×((1−α)×LAEₚᵣₑ₁+α×LAEₚᵣₑ₂), (5)

where (1−α)×LAEₚᵣₑ₁+α×LAEₚᵣₑ₂ is used to estimate the propagated error from two previous reference frames, and wᵢ^{PA} is a weighting factor. In one embodiment, α is set to 0.25 for P frame and 0.5 for B frame, and wᵢ^{PA} is set to 1 for P and B frames which means no artifacts attenuation, and 0.5 for loss-occurred I frame (regardless whether it is a scene-cut frame or not) which means the artifacts is attenuated by half. If an I frame is successfully received without loss, wᵢ^{PA} is set to 0, which means no error propagation.

One frame may be encoded into several slices, for example, in a high-definition IPTV program. Each slice is an independent decoding unit. That is, a lost packet of one slice may cause all following received packets in that slice undecodable; but this lost packet will not influence the decoding of received packets in other slice(s) of the frame. That is, the number of slices in a frame impacts video quality. Thus, in the present embodiments, the number of slices (denoted as s) is considered in quality modeling.

When the video is encrypted, how a frame is partitioned into slices is unknown, and the exact location of a lost packet in the slice is also unknown. In our experiments, we observe that when the perceived video quality is similar, a video sequence with more slices per frame has a larger LAE value than another sequence with fewer slices per frame, even though these two sequences may have similar perceived quality levels and the ALAE values should also be similar. Based on experimental results, we use \sqrt{s} to take into account the effect of the number of slices per frame on the video quality.

The number of slices per frame may be determined from the video applications. For example, a service provider may provide this parameter in a configuration file. If the number of slices per frame is not provided, we set it to a default value, for example, 1.

Using the estimated visible artifact levels (i.e., LAE parameters) and the number of slices in a frame, the average visible artifact level for a video sequence (ALAE) can be calculated as:

$$ALAE = ( \frac{1}{N} {\sum }_{i = 1}^{N} {LAE}_{i} ) / ( f ⋆ \sqrt{s} ) \qquad ( 6 )$$

where N is the number of frames in the video, f is the frame rate, and s is the number of slices per frame.

### Overall Quality Prediction

The video quality is then estimated using the ALAE parameter. In the present principles, the quality prediction model predicts video quality by considering both coding artifacts and channel artifacts.

A video program may be compressed into various coding bitrates, thus with different quality degradation due to video compression. In the present embodiments, using the bitrate parameter, video compression artifacts are taken into account when predicting video quality.

Considering the bitrate parameter and the ALAE parameter, the overall quality for the encrypted video can be obtained, for example, using a logistic function:

$${V}_{q}^{N} = \frac{1}{1 + a ⋆ {Br}^{b} ⋆ {ALAE}^{c}} , \qquad ( 7 )$$

where V_{q}^{N} is a normalized mean opinion score (NMOS) within [0,1]. In Eq. (7), the bitrate parameter Br is used to model coding artifacts and the ALAE parameter is used to model slicing channel artifacts. In Eq. (7), a, b, and c are constants, which may be obtained using a least-square curve fitting method. For example, coefficients a, b, and c may be determined from a training database that is built conforming to ITU-T SG 12.

Various constants are used in the present embodiments, for example, constant 0.5 in Eq. (1.2), weighting factors in Eqs. (4), (5) and TABLE 1, and coefficients a, b, and c in Eq. (7). When the present principles are applied to different systems than those exemplified in the present application, the equations or the values of the model parameters may be adjusted, for example, for new training databases or different video coding methods.

We compared the proposed quality prediction model with other two models described respectively in “Parametric packet-layer model for monitoring video quality of IPTV services,” K. Yamagishi, T. Hayashi, ICC, 2008 (herein after “Yamagishi”) and “Frame-layer packet-based parametric video quality model or encrypted video in IPTV services,” M. N. Garcia, A. Raake, QoMEX, 2011 (hereinafter “Garcia”). Similar to our method, Yamagishi estimates coding degradation using a logistic function of the bitrate parameter, and loss degradation using an exponential function of PLF (packet-loss frequency) parameter. xwpSEQ metric proposed in Garcia is applicable to slicing-type loss degradation, which is fitted by a log function.

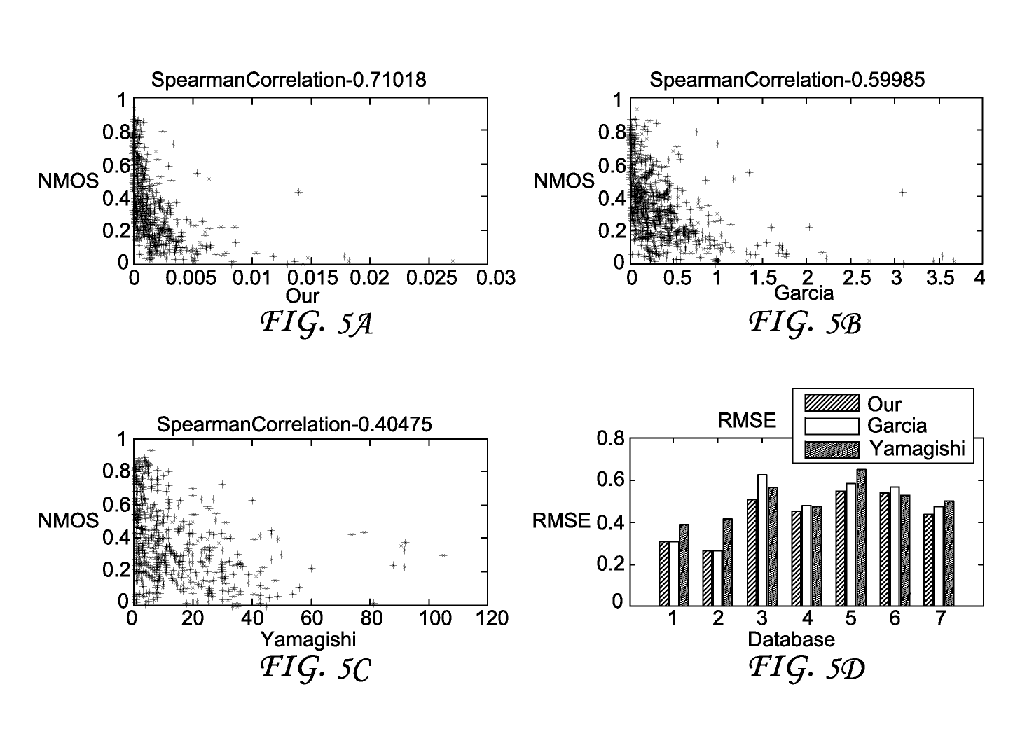

The Spearman correlation of slicing-related metric ALAE in our model, xwpSEQ in Garcia and PLF in Yamagishi are shown in FIGS. 5(A)-(C), respectively In FIGS. 5(A)-(C), the y-axis indicates the NMOS and the x-axis indicates the value of metric in the respective papers. We observe that our proposed method significantly outperforms methods of Yamagishi and Garcia, which indicates that the proposed metric is superior to these and more correlated with the subjective quality. In FIG. 5(D), the Root Mean Square Error (RMSE) between the predicted and subjective quality using our proposed model, model in Yamagishi, and model in Garcia is presented. In FIG. 5(D), the x-axis indicates which database is used, and the y-axis indicates the value of RMSE. The RMSE value generated by our method outperforms or is comparative with the other two models in databases 1-6, and is significantly better in database 7.

In the present application, packet layer quality assessment for monitoring quality of an encrypted video is proposed. The proposed model is applicable to in-service non-intrusive applications, and its computational load is quite light by only using packet header information and does not need access to media signals. An efficient loss-related metric is proposed to predict the visible artifacts and perceived quality. The estimation of visible artifact level is based on the spatio-temporal complexity from frame layer information. The overall quality prediction model is capable of handling videos with various slice numbers and different GOP structures, and considers both coding and channel artifacts. The generality of the model is demonstrated from an adequate amount of training and validation databases with various configurations. The better performance in metric correlation and RMSE comparison shows the superiority of our model.

The present principles can also be used when the video is not encrypted. That is, even if the video payload information becomes available, and more information about the video can be parsed or decoded, the proposed video quality prediction method may still be desirable because of its low complexity.

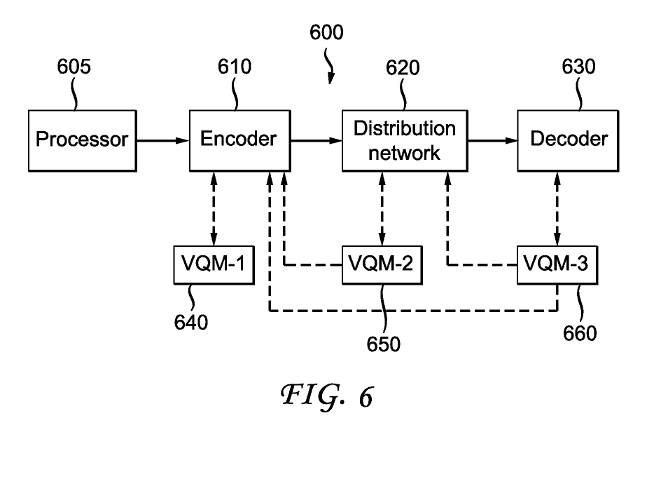

Referring to FIG. 6, a video transmission system or apparatus 600 is shown, to which the features and principles described above may be applied. A processor 605 processes the video and the encoder 610 encodes the video. The bit stream generated from the encoder is transmitted to a decoder 630 through a distribution network 620. A video quality monitor, for example, the quality monitor 100 as shown in FIG. 1, may be used at different stages. Because the quality assessment method according to the present principles does not require access to the decoded video, the decoder may only need to perform de-packetization and header information parsing.

In one embodiment, a video quality monitor 640 may be used by a content creator. For example, the estimated video quality may be used by an encoder in deciding encoding parameters, such as mode decision or bit rate allocation. In another example, after the video is encoded, the content creator uses the video quality monitor to monitor the quality of encoded video. If the quality metric does not meet a pre-defined quality level, the content creator may choose to re-encode the video to improve the video quality. The content creator may also rank the encoded video based on the quality and charges the content accordingly.

In another embodiment, a video quality monitor 650 may be used by a content distributor. A video quality monitor may be placed in the distribution network. The video quality monitor calculates the quality metrics and reports them to the content distributor. Based on the feedback from the video quality monitor, a content distributor may improve its service by adjusting bandwidth allocation and access control.

The content distributor may also send the feedback to the content creator to adjust encoding. Note that improving encoding quality at the encoder may not necessarily improve the quality at the decoder side since a high quality encoded video usually requires more bandwidth and leaves less bandwidth for transmission protection. Thus, to reach an optimal quality at the decoder, a balance between the encoding bitrate and the bandwidth for channel protection should be considered.

In another embodiment, a video quality monitor 660 may be used by a user device. For example, when a user device searches videos in Internet, a search result may return many videos or many links to videos corresponding to the requested video content. The videos in the search results may have different quality levels. A video quality monitor can calculate quality metrics for these videos and decide to select which video to store. In another example, the user device may have access to several error concealment techniques. A video quality monitor can calculate quality metrics for different error concealment techniques and automatically choose which concealment technique to use based on the calculated quality metrics.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bit stream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for estimating video quality of a video, comprising:
accessing a bitstream including the video;
determining a picture type of a picture in the video as one of a scene-cut frame, non scene-cut I frame, P frame, and B frame; and
estimating the video quality for the video in response to the determined picture type.

2. The method of claim 1, wherein the picture type of the picture is determined in response to at least one of a size of the picture and a corresponding GOP length.

3. The method of claim 1, further comprising:
determining an initial visible artifact level in response to the determined picture type of the picture.

4. The method of claim 3, wherein the initial visible artifact level is responsive to a weighting factor, the weighting factor for a scene-cut frame being greater than the weighting factor for a non scene-cut I or P frame.

5. The method of claim 1, further comprising:
determining a propagated visible artifact level in response to the determined picture type of the picture.

6. The method of claim 5, wherein the propagated visible artifact level is responsive to a weighting factor.

7. The method of claim 1, further comprising:
determining an overall artifact level for the picture in response to an initial visible artifact level and a propagated visible artifact level, wherein the video quality for the video is estimated in response to the overall artifact level for the picture.

8. The method of claim 7, wherein the overall artifact level for the picture is weighted in response to the number of slices in the picture to determine the video quality for the video.

9. The method of claim 7, wherein the video includes a plurality of pictures, the determining the picture type and the determining the overall artifact level being performed for each of the plurality of pictures, wherein the video quality for the video is estimated in response to a bitrate parameter and the overall artifact levels for the plurality of pictures.

10. The method of claim 1, further comprising:
performing at least one of monitoring quality of the bitstream, adjusting the bitstream in response to the estimated video quality, creating a new bitstream based on the estimated video quality, adjusting parameters of a distribution network used to transmit the bitstream, determining whether to keep the bitstream based on the estimated video quality, and choosing an error concealment mode at a decoder.

11. An apparatus for estimating video quality of a video included in a bitstream, comprising:
a parameter extractor determining a picture type of a picture in the video as one of a scene-cut frame, non scene-cut I frame, P frame, and B frame; and
a quality estimator estimating the video quality for the video in response to the determined picture type.

12. The apparatus of claim 11, wherein the picture type of the picture is determined in response to at least one of a size of the picture and a corresponding GOP length.

13. The apparatus of claim 11, wherein the parameter extractor determines an initial visible artifact level in response to the determined picture type of the picture.

14. The apparatus of claim 13, wherein the initial visible artifact level is responsive to a weighting factor, the weighting factor for a scene-cut frame being greater than the weighting factor for a non scene-cut I or P frame.

15. The apparatus of claim 11, wherein the parameter extractor determines a propagated visible artifact level in response to the determined picture type of the picture.

16. The apparatus of claim 15, wherein the propagated visible artifact level is responsive to a weighting factor.

17. The apparatus of claim 11, wherein the parameter extractor determines an overall artifact level for the picture in response to an initial visible artifact level and a propagated visible artifact level, and wherein the quality estimator estimates the video quality for the video in response to the overall artifact level for the picture.

18. The apparatus of claim 17, wherein the overall artifact level for the picture is weighted in response to the number of slices in the picture to determine the video quality for the video.

19. The apparatus of claim 17, the video including a plurality of pictures, wherein the parameter extractor determines the picture type and determines the overall artifact level for each of the plurality of pictures, and wherein the quality estimator estimates the video quality for the video in response to a bitrate parameter and the overall artifact levels for the plurality of pictures.

20. The apparatus of claim 11, further comprising:
a video quality monitor performing at least one of monitoring quality of the bitstream, adjusting the bitstream in response to the estimated video quality, creating a new bitstream based on the estimated video quality, adjusting parameters of a distribution network used to transmit the bitstream, determining whether to keep the bitstream based on the estimated video quality, and choosing an error concealment mode at a decoder.

21. (canceled)
